(19) United States
(12) Patent Application Publication
(10) Pub. No.: US 2019/0277402 A1
(43) Pub. Date: Sep. 12, 2019

(54) APPARATUS AND METHODS FOR ADDITIVELY MANUFACTURING O-RING GROOVES

(71) Applicant: DIVERGENT TECHNOLOGIES, INC., Los Angeles, CA (US)

(72) Inventors: William David KREIG, Huntington Beach, CA (US); Eahab Nagi EL NAGA, Topanga, CA (US); Chukwubulkem Marcel OKOLI, Los Angeles, CA (US); David Brian TenHOUTEN, Los Angeles, CA (US); Steven Blair MASSEY, JR., Torrance, CA (US)

(21) Appl. No.: 15/919,129

(22) Filed: Mar. 12, 2018

(51) Int. Cl. F16J 15/328; B29C 64/10; B29C 65/54

(52) U.S. Cl. CPC F16J 15/328; B29L 2031/26; B29C 65/542; B29C 64/10

(57) ABSTRACT

Apparatus and methods for additively manufactured O-ring grooves are presented herein. An O-ring groove is additively manufactured to have a vertical face, bottom face, and an opposite face. By additively manufacturing the opposite face to be outwardly facing with an obtuse angle, the O-ring groove can be built without the need for support structures, thereby reducing post processing steps and manufacturing cost.

### BACKGROUND

### Field

The present disclosure relates generally to techniques for manufacturing grooves, and more specifically to additively manufacturing O-ring grooves.

### Background

Recently three-dimensional (3D) printing, also referred to as additive manufacturing, has presented new opportunities to efficiently build parts for automobiles and other transport structures such as airplanes, boats, motorcycles, and the like. Applying additive manufacturing processes to industries that produce these products has proven to produce a structurally more efficient transport structure. An automobile produced using 3D printed components can be made stronger, lighter, and consequently, more fuel efficient. Advantageously, 3D printing of parts for automobiles can be more eco-friendly than conventional manufacturing techniques.

Automobiles and transport vehicles are constructed with components including panels, extrusions, nodes, and tubes. Nodes are components that may be used to connect various parts of the transport structure together. Nodes may also include structures for performing independent functions. Nodes may be printed with one or more ports and features that enable securing them with other components by injecting an adhesive rather than by traditional welding. Adhesive joining may necessitate building additional features within the nodes in order to facilitate use of adhesive seals.

### SUMMARY

Several aspects of techniques for additively manufacturing O-ring grooves will be described more fully hereinafter with reference to three-dimensional (3D) printing techniques.

In one aspect an additively manufactured node comprises an O-ring groove. The O-ring groove comprises a vertical face, a bottom face, and an opposite face. The opposite face is additively manufactured at a first angle with respect to the vertical face such that the O-ring groove is self-supporting.

The first angle can be between twenty five and sixty five degrees.

The opposite face can be tapered. The opposite face and the bottom face can intersect so as to form a second angle. The opposite face can be additively manufactured at an angle with respect to the vertical face for receiving an O-ring.

The O-ring can be inserted into the O-ring groove along an insertion vector; and the additively manufactured node can be configured for joining with a component via a seal. The O-ring can be inserted into the O-ring groove such that the seal is formed between the additively manufactured node and the component.

The additively manufactured node can be adhered to the component by an adhesive; and the adhesive can be drawn into a sealed region created by the seal.

The component can be a tube. The component can be a panel. The component can be an extrusion. The component can be a node.

In another aspect a method of sealing an additively manufactured node to a component comprises: additively manufacturing an O-ring groove in the additively manufactured node; inserting an O-ring into the O-ring groove along an insertion vector; joining the component to the additively manufactured node at the O-ring groove; and drawing an adhesive into a sealed region formed by the O-ring. The O-ring groove is additively manufactured such that the O-ring groove is self-supporting.

Additively manufacturing the O-ring groove in the additively manufactured node such that the O-ring groove is self-supporting can comprise: additively manufacturing a vertical face; additively manufacturing a bottom face; and additively manufacturing an opposite face at a first angle with respect to the vertical face. The opposite face can be additively manufactured such that the O-ring groove is self-supporting.

The first angle can be between twenty five and sixty five degrees. The first angle can be substantially equal to thirty degrees.

The opposite face can be tapered. The opposite face and the bottom face can intersect so as to form a second angle.

In another aspect a method of additively manufacturing an O-ring groove in a first component comprises: additively manufacturing a vertical face; additively manufacturing a bottom face; and additively manufacturing an opposite face at a first angle with respect to the vertical face. The second angle is an angle with respect to the bottom and opposite faces and is at a value such that the O-ring groove is self-supporting.

The first angle can be between twenty five and sixty five degrees. The first angle can be substantially equal to thirty degrees. The opposite face can be tapered.

It will be understood that other aspects of additively manufacturing O-ring grooves will become readily apparent to those skilled in the art from the following detailed description, wherein it is shown and described only several embodiments by way of illustration. As will be appreciated by those skilled in the art, the additively manufactured O-ring grooves can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatus and methods for additively manufacturing O-ring grooves will now be presented in the detailed description by way of example, and not by way of limitation, in the accompanying drawings, wherein:

FIG. 1A illustrates an additively manufactured (AM) part including an AM O-ring groove according to the teachings herein.

FIG. 1B illustrates the AM part of FIG. 1A with an O-ring.

FIG. 1C illustrates a rotated view of the AM part of FIG. 1A.

FIG. 2A illustrates a two-dimensional (2D) projection of an O-ring groove according to the teachings herein.

FIG. 2B illustrates geometrical features of the two-dimensional (2D) projection of FIG. 2A.

FIG. 3A illustrates an additively manufactured (AM) part including AM O-ring grooves according to an embodiment.

FIG. 3B illustrates the AM part of FIG. 3A with O-rings.

FIG. 3C illustrates the insertion of a second part over the AM part of FIG. 3B according to an embodiment, and an exploded view of the O-ring contacting the second part to form a seal.

FIG. 4 illustrates a conceptual flow diagram for additively manufacturing an O-ring groove according to the teachings herein.

### DETAILED DESCRIPTION

The detailed description set forth below in connection with the drawings is intended to provide a description of exemplary embodiments of additively manufacturing O-ring grooves, and it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of additive manufacturing in the context of O-ring grooves provides significant flexibility and cost saving benefits that enable manufacturers of mechanical structures and mechanized assemblies to manufacture parts and components with complex geometries at a lower cost to the consumer. The O-ring grooves and techniques for additively manufacturing O-ring grooves described herein may relate to one of the steps in the overall process of connecting additively manufactured parts and/or commercial off the shelf (COTS) components. Additively manufactured (AM) parts are printed three-dimensional (3D) parts that are printed by adding layer upon layer of a material based on a preprogramed design. The parts described in the foregoing may be parts used to assemble a transport structure such as an automobile. However, those skilled in the art will appreciate that the manufactured parts may be used to assemble other complex mechanical products such as vehicles, trucks, trains, motorcycles, boats, aircraft, and the like without departing from the scope of the invention.

Additive manufacturing provides the ability to create complex structures within a part. For example, a node is a structural member that may include one or more interfaces used to connect to other spanning components such as tubes, extrusions, panels, other nodes, and the like. Using additive manufacturing, a node may be constructed to include additional features and functions as noted above, depending on the objectives. For example, a node may be printed with one or more ports that enable the ability to secure two or more components by injecting an adhesive rather than by traditional welding.

Prior to connecting additively manufactured nodes to components such as tubes, extrusions, panels, and/or other nodes, an O-ring (or multiple O-rings) may be used in the adhesive joining process. O-ring grooves can be additively manufactured in the nodes for the placement of O-rings between two or more components. O-rings can advantageously provide isolation between two or more components being connected while enabling the formation of a hermetic seal.

For instance, O-rings can be placed in O-ring grooves so that the components being connected do not come into physical contact with each other. This can be particularly useful in cases where components made with dissimilar materials are being connected (e.g., an aluminum additively manufactured node joined with a carbon fiber reinforced polymer composite tube). Without such isolation, galvanic corrosion and other problems may result over time. The isolation can be adjusted such that the required amount of spacing between the components is obtained to ensure that an optimal thickness of adhesive bond is obtained.

O-rings can ensure hermetically sealed enclosures. For instance, during adhesive injection, one or more O-rings can ensure that regions are evacuated and hermetically sealed when a vacuum is drawn through channels. By first evacuating a channel with a vacuum or negative pressure source, a hermetic seal is formed along the channel path as adhesive is drawn by the vacuum. Once the path is completely evacuated, adhesive may be injected, and one or more O-rings may be present to ensure that the adhesive is hermetically sealed in the adhesive region.

After the adhesive is cured and a bond forms between the components, the O-rings can advantageously maintain the hermetic seal. During operation of the component, the O-ring can ensure that the adhesive bond is not exposed to the environment, thereby reducing contamination or degradation of the adhesive bond by foreign particles and/or chemicals.

Despite these advantages, additively manufacturing conventional O-ring groove geometries can present post-processing challenges. O-ring grooves with conventional O-ring groove geometries, including dovetail, square, half dovetail, and the like, typically require traditional machining operations to efficiently create functional seals between components. However, in embodiments using additively manufactured components, conventional O-ring grooves may not be easily printed using additively manufactured techniques, as explained below.

Instead, O-ring grooves typically require inclusion of support structures to support various portions of the grooves owing to the groove geometry and material (e.g. metal). Upon completion of the additive manufacturing printing steps, these support structures need to be carefully and completely removed using an intricate, time-consuming post-processing procedure. These procedures are time consuming because the structures that require removal may be relatively small compared to the overall structures and may be immediately adjacent other 3D printed material. Thus, care must be taken to remove only the support material and all of the support material, and not to inadvertently remove portions of the structures in which the O-ring grooves are included. Thus, post processing procedures represent an undesirable manufacturing step adding cost and time to the production cycle. Accordingly, one solution to this problem is to establish and identify new O-ring groove geometries to overcome the need for structural supports.

Apparatus and method for additively manufactured O-ring grooves are accordingly presented herein. An O-ring groove may be additively manufactured to have geometrical features including a vertical face, a bottom face, and an opposite face. By additively manufacturing the opposite face to be outwardly facing with a second angle, the O-ring groove can be built without the need for support structures, thereby reducing post processing steps and manufacturing cost. This also allows the additive manufacturing of co-printed parts with contiguous O-ring grooves providing sealing features across complex surfaces without traditional machining.

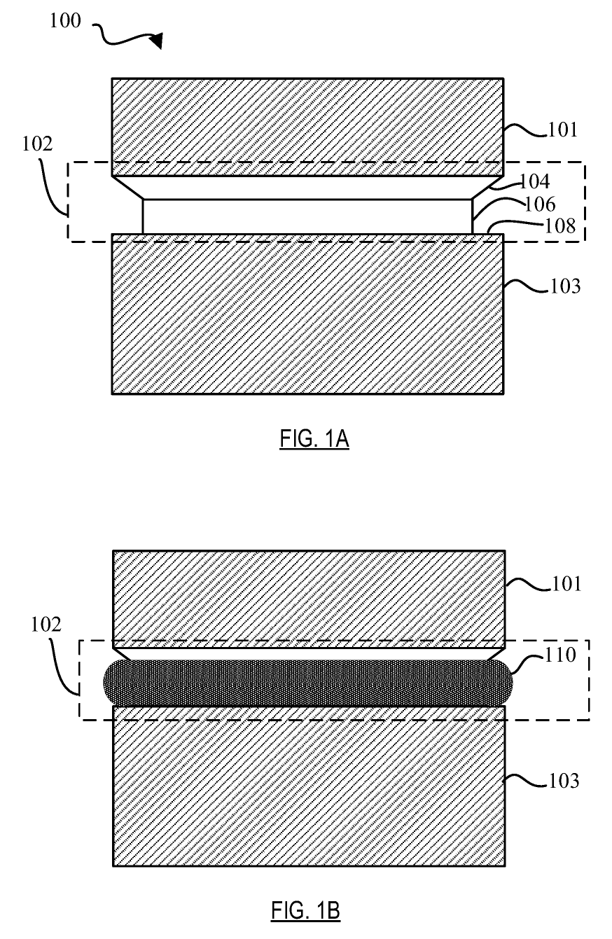

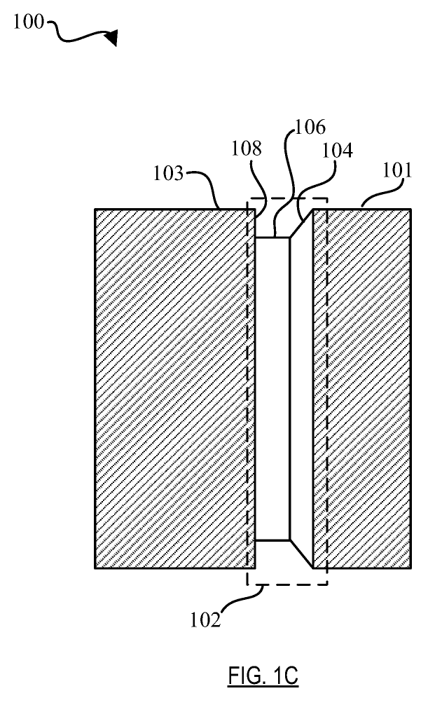

FIG. 1A illustrates an additively manufactured (AM) part 100 including an AM O-ring groove 102 according to the teachings herein. FIG. 1B illustrates the AM part 100 of FIG. 1A with an O-ring 110; and FIG. 1C illustrates a rotated view of the AM part 100 of FIG. 1A. Geometrical features of the AM O-ring groove 102 include a vertical face 108, a bottom face 106, and an opposite vertical face 104, additively manufactured for placing the O-ring 110 (FIG. 1B) between a first part region 101 and a second part region 103. The part 100 can be a three dimensional additively manufactured node, part, a component with a partial or full cylindrical or round circumference, or a perimeter of essentially any shape whether or not it has the symmetry of a particular shape. By additively manufacturing the opposite face 104 to slant away from the vertical face 108 so as to form an obtuse angle with the bottom face 106, the AM O-ring groove 102 can be additively manufactured without the need for support structures. That is, using an appropriate obtuse angle (>90° and <180°), the AM part 100 can be configured to effectively support itself O-ring grooves may therefore be self-supporting, meaning that during the 3D printing process, no separate support structures or supporting material is needed to maintain the shape or integrity of the O-ring grooves.

Although FIGS. 1A-C show an embodiment of an AM part 100 with only one AM O-ring groove 102 and O-ring 110, components and parts having more than one AM O-ring are possible. Also, other embodiments may be contemplated in which a more complex set of groove features are present; these structures are intended to fall within the scope of the present disclosure so long as they provide a vertical/opposite face with the identified obtuse angle to obviate the need for support structure. The angle may fall between twenty-five (25) and sixty-five (65) degrees, inclusive. In a further embodiment, the angle is substantially thirty (30) degrees. “Substantially” as defined with respect to this angle of 30 degrees means that the angle can vary by plus (+) or minus (−) three (3) degrees. It will be understood, however, that different ranges of angles in practice are possible and may vary with the implementation.

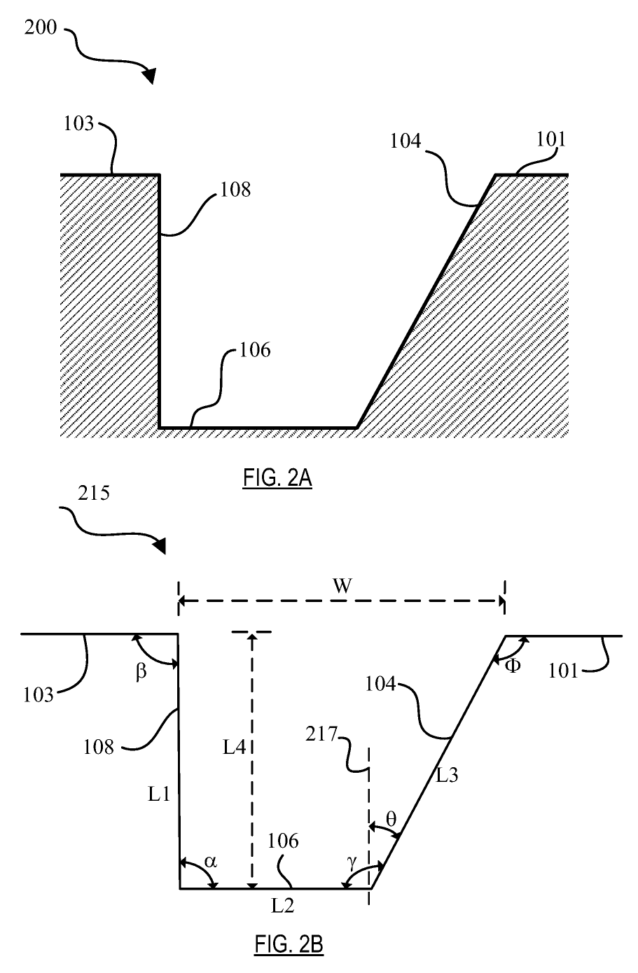

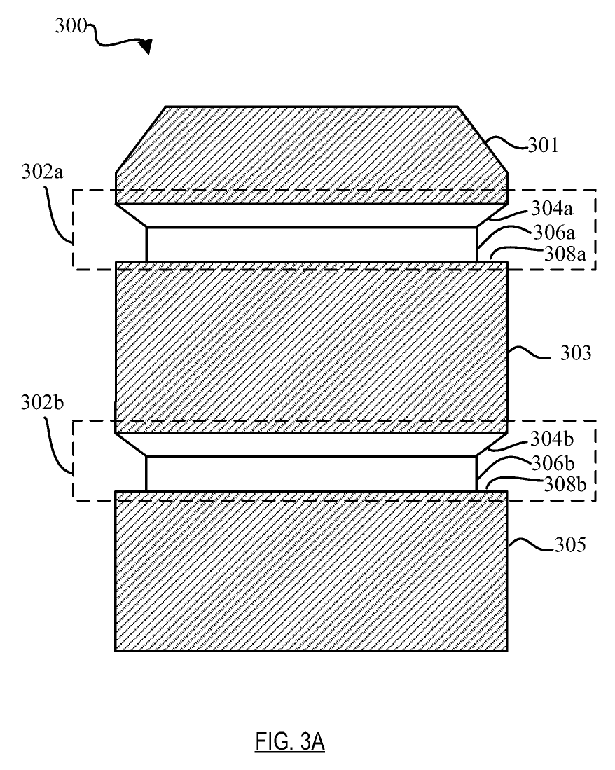

FIG. 2A illustrates a two-dimensional (2D) projection 200 of the AM O-ring groove 102 according to the teachings herein; and FIG. 2B illustrates geometrical features 215 of the two-dimensional (2D) projection 200 of FIG. 2A. The 2D projection 200 shows the vertical face 108, the bottom face 106, and the opposite face 104 between the first part region 101 and the second part region 103.

The geometrical features 215 show a groove width W, a vertical face length L1, a bottom face length L2, an opposite face length L3, and a groove depth L4. In addition, the geometrical features 215 include an angle β between the second part region 103 and the vertical face 108, an angle α between the vertical face 108 and the bottom face 106, an angle γ between the bottom face 106 and the opposite face 104, and an angle (Φ) between the opposite face 104 and the first part region 101. As illustrated, the opposite face 104 is additively manufactured, and the angle y is formed between the opposite face 104 and the bottom face 106 and is obtuse. The angular differential amount of γ extending beyond ninety degrees is given by another angle θ between a normal line 217 and the opposite face 104, which can be tailored prior to additive manufacturing so that the AM O-ring groove 102 accepts an appropriate-sized O-ring 110 and so as to eliminate the need for support structures.

The normal 217 can be chosen as a reference line normal to the surface of the bottom face 106 or as a reference line parallel to the vertical face 108. For instance, if the normal 217 is defined as a reference line parallel to the vertical face 108, then the angle θ is equivalent to the angle between the vertical face 108 and the opposite face 104. For example, if the angle θ is thirty degrees, then the angle between the vertical face 108 and the opposite face 104 is also thirty degrees.

Although the edges defining the angle a between the vertical face 108 and the bottom face 106 and the angle y between the bottom face 106 and the opposite face 104 show sharp corners (vertices), other configurations are possible. For instance, fillets can be additively manufactured at the edges so as to provide rounded corners.

The geometrical features 215 can be also tuned and/or numerically derived prior to additively manufacturing the AM O-ring groove 102. In this way the AM O-ring groove 102 can be tailored to position an O-ring groove while also eliminating the need for support structures. A typical range of values for the angle θ can be between twenty five and sixty five degrees. For instance, in one embodiment the angle θ may be thirty degrees.

For the purposes of this disclosure, the first angle is angle θ, the second angle is the angle γ. The geometrical features 215 including the groove width W, vertical face length L1, bottom face length L2, opposite face length L3, groove depth L4 can also be selected based in part upon the type and/or characteristics of the O-ring 110. For instance, the groove width W and groove depth L4 can be increased to accommodate a thicker/wider O-ring 110. In addition, the angle β, the angle a and the angle (Φ) can depend, at least in part, on the structural requirements of the AM part 100. For instance, when the AM part 100 is a node, the angle β, the angle a can be equal or substantially equal to ninety degrees.

However, as one of ordinary skill in the art can appreciate, there can be variations. For instance, the angle α, defined between the vertical face 108 and the bottom face 106 can vary within approximately plus and minus five degrees. Thus, vertical can mean “substantially” vertical—namely, vertical to within the tolerance of the additive manufacturing resolution.

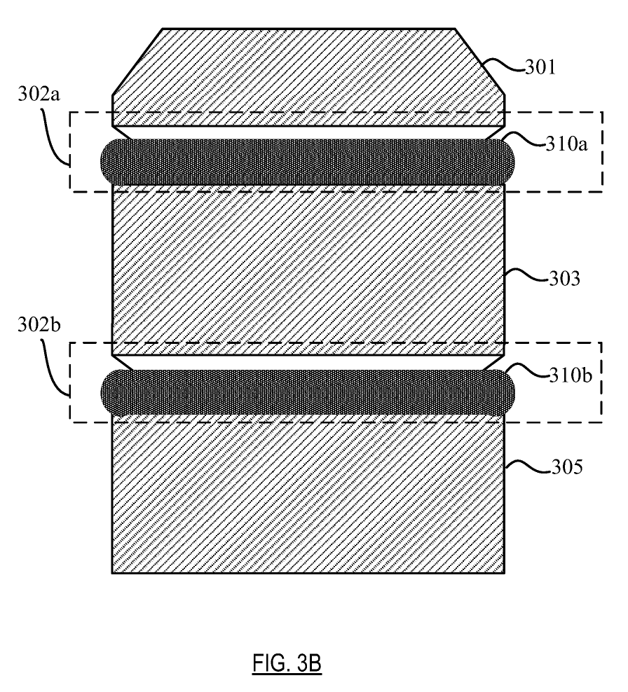

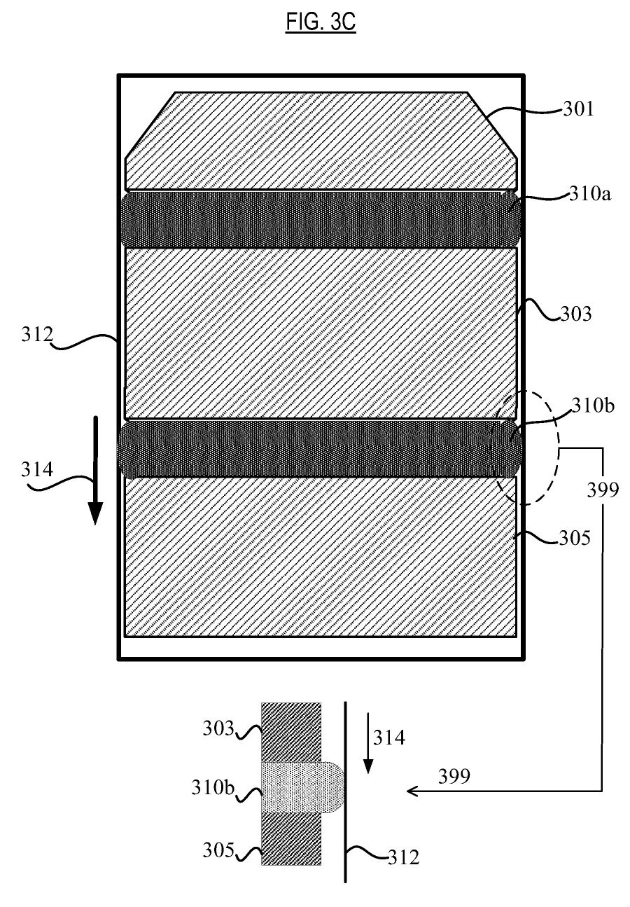

FIG. 3A illustrates an additively manufactured (AM) part 300 including AM O-ring grooves 302a-b according to an embodiment. FIG. 3B illustrates the AM part 300 of FIG. 3A with O-rings 310a-b; and FIG. 3C illustrates the insertion of a second part 312 over the AM part 300 of FIG. 3B according to an embodiment. The AM part 300 can be similar to the AM part 100 except it includes two AM O-ring grooves 302a-b. The AM O-ring groove 302a includes a vertical face 308a, a bottom face 306a, and an opposite face 304a, additively manufactured for placing the AM O-ring 310a between a first part region 301 and a second part region 303; and the AM O-ring groove 302b includes a vertical face 308b, a bottom face 306b, and an opposite face 304b, additively manufactured for placing the AM O-ring 310b between the second part region 303 and a third part region 305.

Like the AM O-ring groove 102, the AM O-ring grooves 302a-b can be additively manufactured so that the opposite faces 304a-b slant away from the vertical faces 308a-b to form obtuse angles with the bottom faces 306a-b. In this way the AM O-ring grooves 302a-b can be additively manufactured without requiring support structures to act against the downward gravitational forces.

The part 300 can be a three dimensional additively manufactured node for joining with the second part 312 (FIG. 3C). The second part can be a component and/or tube which may be joined with the node using an adhesive.

In embodiments utilizing O-rings to form the seal, the orientation of the groove in the part would be driven by the part insertion vector, to ensure that the O-ring is successfully retained during the assembly process. As shown in FIGS. 3A-C, the O-ring rings 310a-b can be placed in the AM O-ring grooves 302a-b such that when the second part 312 is inserted in the direction of the insertion vector 314, the O-rings 310a-b are supported by the vertical faces 308a-b. With further reference to FIG. 3C, view 399 is exploded to show a partial cross-sectional view of the part 300. As shown, O-ring 310b forms a seal with the second part 312 between second part region 303 and third part region 305. While this exploded view is shown with respect to one side of one O-ring 310b, it will be appreciated that a similar seal will be formed at the other end of O-ring 310b as well as both ends of O-ring 310a.

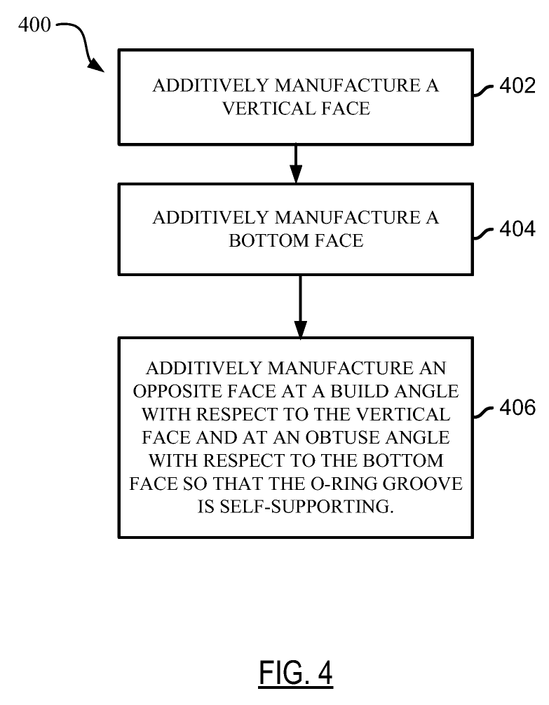

FIG. 4 illustrates a conceptual flow diagram 400 for additively manufacturing an O-ring groove 102 according to the teachings herein. In the first step 402, a vertical face (e.g. vertical face 108) is additively manufactured. In the next step 404, a bottom face (e.g. bottom face 106) is additively manufactured; and in step 406, an opposite face (e.g. opposite face 104) is additively manufactured. The opposite face 104 is additively manufactured to make an obtuse angle the bottom face 106 having an angle between the vertical face 108 and the opposite face 104. The obtuse angle can be the second angle γ, and the first angle can be θ. By having an angle θ between twenty five degrees and 65 degrees an O-ring groove 102 can be built without the need for support structures. Thus with a predefined angle θ, a part 100 can be manufactured without requiring support structures.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for additively manufacturing O-ring grooves. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An additively manufactured node comprising:
an O-ring groove, the O-ring groove comprising:
a vertical face;
a bottom face; and
an opposite face,
wherein the opposite face is additively manufactured at a first angle with respect to the vertical face such that the O-ring groove is self-supporting.

2. The additively manufactured node of claim 1, wherein the first angle is between twenty five and sixty five degrees.

3. The additively manufactured node of claim 2, wherein the first angle is substantially equal to thirty degrees.

4. The additively manufactured node of claim 1, wherein the opposite face is tapered.

5. The additively manufactured node of claim 1, wherein the opposite face and the bottom face intersect at a second angle.

6. The additively manufactured node of claim 1, wherein the opposite face is additively manufactured at a first angle with respect to the vertical face for receiving an O-ring, the O-ring inserted into the O-ring groove along an insertion vector.

7. The additively manufactured node of claim 6 configured for joining with a component via a seal, the O-ring inserted into the O-ring groove such that the seal is formed between the additively manufactured node and the component.

8. The additively manufactured node of claim 7, wherein the additively manufactured node is adhered to the component by an adhesive, the adhesive drawn into a sealed region created by the seal.

9. The additively manufactured node of claim 7, wherein the component comprises a tube.

10. The additively manufactured node of claim 7, wherein the component comprises a panel.

11. The additively manufactured node of claim 7, wherein the component comprises an extrusion.

12. The additively manufactured node of claim 7, wherein the component comprises a node.

13. A method of sealing an additively manufactured node to a component, the method comprising:
additively manufacturing an O-ring groove in the additively manufactured node such that the O-ring groove is self-supporting;
inserting an O-ring into the O-ring groove along an insertion vector;
joining the component to the additively manufactured node at the O-ring groove; and
drawing an adhesive into a sealed region formed by the O-ring.

14. The method of claim 13, wherein additively manufacturing the O-ring groove in the additively manufactured node such that the O-ring groove is self-supporting comprises:
additively manufacturing a vertical face;
additively manufacturing a bottom face; and
additively manufacturing an opposite face at a first angle with respect to the vertical face such that the O-ring groove is self-supporting.

15. The method of claim 14, wherein the first angle is between twenty five and sixty five degrees.

16. The method of claim 15, wherein the first angle is substantially equal to thirty degrees.

17. The method of claim 14, wherein the opposite face is tapered.

18. The method of claim 14, wherein the opposite face and the bottom face intersect so as to form an obtuse angle.

19. A method of additively manufacturing an O-ring groove in a first component, the method comprising:
additively manufacturing a vertical face;
additively manufacturing a bottom face; and
additively manufacturing an opposite face at a first angle with respect to the vertical face and at an second angle with respect to the bottom face such that the O-ring groove is self-supporting.

20. The method of claim 19, wherein the first angle is between twenty five and sixty five degrees.

21. The additively manufactured node of claim 20, wherein the first angle is substantially equal to thirty degrees.

22. The method of claim 21, wherein the opposite face is tapered.
